(19) United States
(12) Patent Application Publication
(10) Pub. No.: US 2026/0360152 A1
(43) Pub. Date: Nov. 12, 2026

(54) SYSTEMS AND METHODS FOR REAL-TIME BAGGAGE DETECTION, MEASUREMENT, AND ANALYTICS IN TRANSPORTATION ENVIRONMENTS

(71) Applicant: Arrow Analytics, Inc., Mechanicsburg, PA (US)

(72) Inventors: Akshaj KUMAR, Houston, TX (US); Samuel CROW, College Station, TX (US); Kareem ELDAHSHOURY, Eden Prairie, MN (US)

(21) Appl. No.: 19/671,150

(22) Filed: May 7, 2026

Related U.S. Application Data
(60) Provisional application No. 63/801,715, filed on May 7, 2025.
(60) Provisional application No. 63/890,210, filed on Sep. 29, 2025.

(51) Int. Cl. G06V 20/52; G06Q 50/40; G06T 7/62; G06T 17/00; G06V 10/26; G06V 10/44; G06V 10/70; G06V 40/10

(52) U.S. Cl. CPC G06V 20/53; G06Q 50/40; G06T 7/62; G06T 17/00; G06V 10/26; G06V 10/44; G06V 10/70; G06V 40/10; G06T 2207/30232; G06T 2207/30242

(57) ABSTRACT

A system and method for detecting, sizing, and managing carry-on luggage at airport boarding gates uses AI-based camera frame detection, as well as detecting and determining an available space on an airplane before and during the boarding process. One or more cameras capture images, which are processed using convolutional neural networks, corner detection, segmentation, and edge detection to estimate luggage dimensions. Person and pose detection refine estimates by analyzing contextual relationships. A database of known luggage images or 3D models, augmented by generative methods, enables precise sizing. The system outputs real-time data to gate agents, including annotated video feeds and alerts for oversized bags, and integrates with airline systems for bin assignment and delay analysis, improving boarding efficiency and passenger experience.

### CROSS-REFERENCE TO RELATED APPLICATIONS

This application claims the benefit of provisional U.S. Application No. 63/801,715 entitled “System and Method for AI-Based Detection and Sizing of Carry-On Luggage at Airport Boarding Gates” filed May 7, 2025, and provisional U.S. Application No. 63/890,210 entitled “Systems and Methods for Real-Time Baggage Detection, Measurement, and Analytics in Transportation Environments” filed Sep. 29, 2025, the technical disclosure of both of which are incorporated herein by reference in their entirety.

### TECHNICAL FIELD

The present disclosure relates in general to the field of transportation technologies, and more particularly to a novel system and method for detecting, measuring, tracking, and managing passenger luggage, and detecting and determining an available storage space on a carrier.

### BACKGROUND

Air travel efficiency is significantly impacted by carry-on baggage sizing and management. Current sizing and enforcement mechanisms primarily rely on manual inspection by gate agents, wherein gate agents make subjective decisions about whether luggage exceeds size limits, whether passengers have surpassed their carry-on allowance, and whether remaining storage capacity is sufficient. These approaches lack precision, flexibility, or integration with airline systems. For example, these approaches introduce inconsistency and human error, are slow and disruptive, and lead to frequent disagreements over bag sizes.

These inefficiencies manifest as boarding delays, which in turn increase operational costs for airlines, damage airport reputations, and frustrate passengers. Industry data indicates that boarding delays related to baggage can add 5-15 minutes per flight, cumulatively costing airlines billions annually in lost efficiency. These inefficiencies also lead to suboptimal use of overhead bin space and passenger frustration due to lack of predictable structure in the gate check process.

There is a need for an automated, accurate, and scalable system that leverages advanced AI and computer vision to detect and size objects such as carry-on luggage in real time, while providing actionable data to carriers or conveyers of the objects such as gate agents and passengers. Such a system should accommodate various camera types, environmental conditions, and luggage shapes, and seamlessly integrate with airline and passenger interfaces.

### SUMMARY

Novel aspects of the present disclosure are directed to a system for detecting, sizing, and managing luggage, comprising at least one camera configured to capture images of luggage and a memory storing captured images, reference images and dimensions, generated output, and instructions. The system also includes a processor communicatively coupled to the one or more sensors and the memory, wherein the processor is configured to execute the instructions to analyze the captured images in real time using artificial intelligence and computer vision techniques to determine characteristics associated with each piece of luggage, associate each piece of luggage with a carrier for transport, and generate output corresponding to object characteristics. The system also includes a user interface communicatively coupled to the processor and configured to display generated output to a gate agent and integrate with airline systems.

In another embodiment, novel aspects of the disclosed principles are directed to a method for detecting, sizing, and managing luggage, comprising the steps of capturing images of luggage using at least one camera, processing the images using artificial intelligence and computer vision techniques to detect and estimate characteristics associated with each piece of luggage, associating each piece of luggage with a carrier for transport, and outputting luggage characteristics to a user interface for a gate agent and airline system.

Other aspects, embodiments, and features of the disclosed principles will become apparent from the following detailed description when considered together with the accompanying figures. In the figures, each identical or substantially similar component that is illustrated in various figures is represented by a single numeral or notation. For the purposes of clarity, not every component is labeled in every figure. Nor is every component of each embodiment of the disclosed principles shown where illustration is not necessary to allow those of ordinary skill in the art to understand the principles disclosed herein. While certain features of the currently disclosed subject matter are described for illustrative purposes in relation to a system and method for AI-based detection and sizing of carry-on luggage at airport boarding gates, it should be readily understood that such features are not intended to be limiting. The claims that follow this disclosure are intended to define the scope of the protected subject matter.

### BRIEF DESCRIPTION OF THE DRAWINGS

The novel features believed characteristic of the disclosure are set forth in the appended claims. The disclosure itself, however, as well as a preferred mode of use, further objectives, and advantages thereof, will be best understood by reference to the following detailed description of illustrative embodiments when read in conjunction with the accompanying drawings, in which:

FIG. 1 illustrates a schematic diagram illustrating a luggage detection, sizing, and management system in accordance with an illustrative embodiment;

FIG. 2 illustrates camera-and AI-based detection of a number of luggage units;

FIG. 3 illustrates a before and after imaging by a camera and sizing detection, respectively;

FIG. 4 illustrates an exemplary corner detection of a piece of luggage using a Harris Corner Detection algorithm;

FIG. 5 illustrates assumptions by the size and location determination algorithm executed by the system described herein;

FIG. 6 illustrates internal factors of a camera platform that can be controlled in the system described herein;

FIG. 7 illustrates external factors of a camera platform that can be controlled in the system described herein;

FIG. 8 illustrates an exemplary real-time comparison of a captured image to images in a database for real-time determination of sizing;

FIG. 9 illustrates an exemplary real-time comparison of a captured image to images stored in a database for real-time determination of sizing using an autoencoder;

FIG. 10 illustrates an exemplary three-dimensional model generated from one or more two-dimensional images;

FIG. 11 illustrates an exemplary sizing determination and comparison to available storage space within an aircraft;

FIG. 12 shows various key components of a system as described herein;

FIG. 13 illustrates an exemplary output for display via a user interface generated by the system described herein;

FIG. 14 illustrates a further exemplary output for display via a user interface generated by a system described herein;

FIG. 15 illustrates a graph depicting the relationship between delays and the number of bags to be carried on an airplane using conventional baggage management systems;

FIG. 16 illustrates an additional exemplary output for display via a user interface generated by the system described herein;

FIG. 17 illustrates an exemplary boarding pass providing information generated by the system described herein;

FIG. 18 is a schematic diagram illustrating an exemplary sensor pod for use with the system described herein;

FIG. 19 is a flowchart depicting a data alignment and preprocessing layer of the system described herein;

FIG. 20 is a flowchart illustrating a baggage detection and measurement layer of the system described herein;

FIG. 21 is a flowchart representing an analytics layer of the system described herein;

FIG. 22 is an exemplary output for display via a user interface for a gate agent dashboard;

FIG. 23 is an exemplary digital three-dimensional reconstruction of a piece of luggage, in accordance with the system described herein; and

FIG. 24 is a flowchart illustrating a method of detecting, sizing, and managing luggage in accordance with the description provided herein.

### DETAILED DESCRIPTION

Airlines enforce strict size restrictions for carry-on luggage to ensure efficient boarding, adequate overhead bin storage, and compliance with safety regulations. Air travel efficiency is significantly impacted by carry-on baggage sizing and management. Current sizing and enforcement mechanisms primarily rely on manual inspection by gate agents, static metal baggage sizers positioned at boarding gates, or rudimentary imaging. In practice, gate agents are tasked with making rapid, often subjective decisions about whether luggage exceeds size limits, whether passengers have surpassed their carry-on allowance, and whether remaining storage capacity is sufficient. These approaches lack precision, flexibility, or integration with airline systems. For example, these approaches introduce inconsistency and human error as manual assessments are subjective, vary between agents, and lead to uneven enforcement of baggage size policies. Current sizing and enforcement approaches are also slow and disruptive as passengers must often stop to fit bags into sizers, causing bottlenecks during boarding and extending turnaround times for aircraft. These approaches also lead to frequent disagreements over bag sizes, which can escalate and require additional staff intervention.

These inefficiencies manifest as boarding delays, which in turn increase operational costs for airlines (e.g., fuel consumption during ground holds), damage airport reputations through poor on-time performance metrics, and frustrate passengers with unpredictable experiences. Industry data indicates that boarding delays related to baggage can add 5-15 minutes per flight, cumulatively costing airlines billions annually in lost efficiency.

In other sectors, such as logistics and warehousing, automated 3D measurement systems (e.g., laser scanners or vision-based dimension-sensing systems) are employed to size packages accurately. However, these systems are ill-suited for airport applications due to their inherent assumptions and design constraints. For example, these systems process isolated, stationary packages on conveyor belts, as opposed to moving baggage intermingled with passengers. Additionally, operation of automated 3D measurement systems requires a controlled environment including uniform lighting, minimal occlusions, and structured pathways, which are absent in crowded, variable airport settings. Finally, these industrial systems are not engineered for safe, seamless integration into spaces shared with people and can be hazardous or require human intervention.

Novel aspects of this disclosure recognize the need for an improved luggage sizing and management system. To this end, an improved luggage detection, sizing, and management system is provided that allows carriers to virtually detect and measure passengers' luggage before and during carrier boarding. More particularly, the system comprises one or more imaging devices configured to detect, track, count, and estimate physical dimensions of objects moving through a shared physical space. The system is designed to operate in dynamic environments where objects may be partially occluded, associated with individuals, and observed from multiple viewpoints. Passengers may additionally provide luggage data via a user interface. Based on collected luggage data, the system can determine an available space (which is decremented based on an onboarding of each unit of the one or more objects) in the carriage platform by calculating and correlating the sizing of luggage with the available space in real time. The system and method can also determine, in real time, an assignment of a storage area of each object within the available space of the carriage platform and assign luggage to optimal bin space. The system described herein provides an automated, accurate, and scalable system that leverages advanced AI and computer vision to detect and size objects such as carry-on luggage in real time, while providing actionable data to carriers or conveyers of the objects such as gate agents and passengers.

Furthermore, the system described herein integrates modular sensor pods, flexible remote/edge processing for location independence, multi-sensor temporal and spatial alignment of distributed sources, robust, dynamic measurements in human settings, and actionable, carrier-tailored analytics into a luggage detection, sizing, and management system, offering scalable solutions for airports and similar venues, reducing delays, boosting efficiency, and improving experiences.

The systems and methods described herein provide improvement over existing baggage management systems. More particularly, the system described herein surpasses static metal sizers by being automated and non-intrusive and outperforms manual inspections with consistency and speed. The system also exceeds industrial scanners by handling human dynamics and improves on vision-only AI with integrated analytics and robustness. The systems and methods described herein combine multiple AI and imaging techniques for precise sizing, and support various camera types and environmental conditions. These systems and methods integrate with existing airline systems for widespread adoption, which reduces boarding delays by automating luggage inspection. The systems and methods disclosed herein enhances convenience through bin assignments and clear compliance feedback.

While the embodiments described herein focus on luggage detection, sizing, and management in air travel, the system may be implemented in any carrier industry. Non-limiting examples include airplane, ship, bus, train, ferry, automobile, or other carriers. System 100 may also be implemented in non-transportation contexts, including, for example, enforcement of bag policies in stadiums and arenas and crowd management in theme parks or event venues. System 100 may also be implemented in security checkpoints for automated screening.

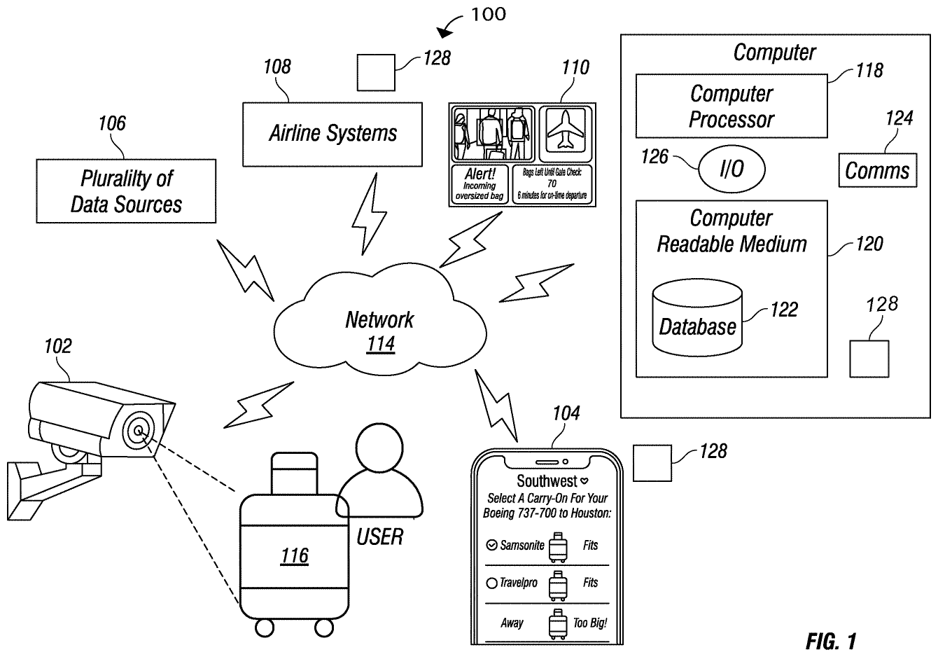

Referring to FIG. 1, illustrated is a schematic diagram of a luggage detection, sizing, and management system 100 designed and constructed in accordance with the disclosed principles. Generally, system 100 includes one or more sensors 102, mobile devices 104, a plurality of data sources 106, airline systems 108, and a gate agent user interface 110, communicating with a server 112 via a network 114 to detect, size, and manage luggage associated with a particular flight. Examples of mobile device 104 can include cell phones, tablets, or any other form of communications device that permits access to the server 104 via the network 114. The network 114 can include the internet, the Public Switched Telephone Network (PSTN), cellular networks, and local area networks, among others. Communication over the network 114 can be achieved using various forms of communications equipment and protocols. The plurality of data sources 106 and airline systems 108 may provide additional information for luggage analysis and storage determinations. For example, airline systems 108 may provide information for association of passengers and/or baggage with a particular flight. Airline systems 108 may also provide information regarding carrier storage space and size restrictions.

System 100 may include one or more sensors 102 for collecting data associated with luggage 116. In the non-limiting exemplary embodiment illustrated in FIG. 1, sensors 102 may include one or more visual capturing or recording devices such as a camera to measure the dimensions of baggage before it is loaded onto an aircraft for a flight. Sensor 102 may capture video or still images of passengers and their luggage in various locations of the airport. Sensors 102 may include a variety of camera types, including but not limited to CCTV cameras, smartphones, webcams, or other imaging devices. Camera types may also include, for example, depth cameras (e.g., RGB-D cameras capable of generating depth maps), LiDAR units (for high-precision 3D point clouds), or optical sensors (e.g., infrared cameras for low-light conditions). The system can operate with a single sensor 102 (for detection, tracking, and approximate sizing) or multiple sensors 102 (for improved accuracy, reduced occlusion, and better 3D estimation). In an embodiment, sensors 102 may be positioned proximate to a boarding gate. In an embodiment comprising multiple sensors 102, sensors 102 may be positioned a few feet apart with overlapping fields of view. Sensor 102 positions may be fixed and calibrated so their relative positions are known. Sensors 102 may continuously capture luggage data. Luggage data captured by the sensors 102 may be sent to the server 112 via the network 114 for analysis and storage.

Server 112 is a computing device that can include hardware and software configured to analyze captured luggage data to detect, size, and manage luggage throughout the airport. Server 112 may include at least one processing unit 118 operably coupled to at least one computer readable medium 120, database 122, at least one communications interface 124, and at least one input/output (I/O) unit 126.

Computer readable medium 120 is any structure(s) capable of storing and facilitating retrieval of information (such as data, program code, and/or other suitable information on a temporary or permanent basis). For example, computer readable medium 120 may represent a random access memory or any other suitable volatile or non-volatile storage device(s).

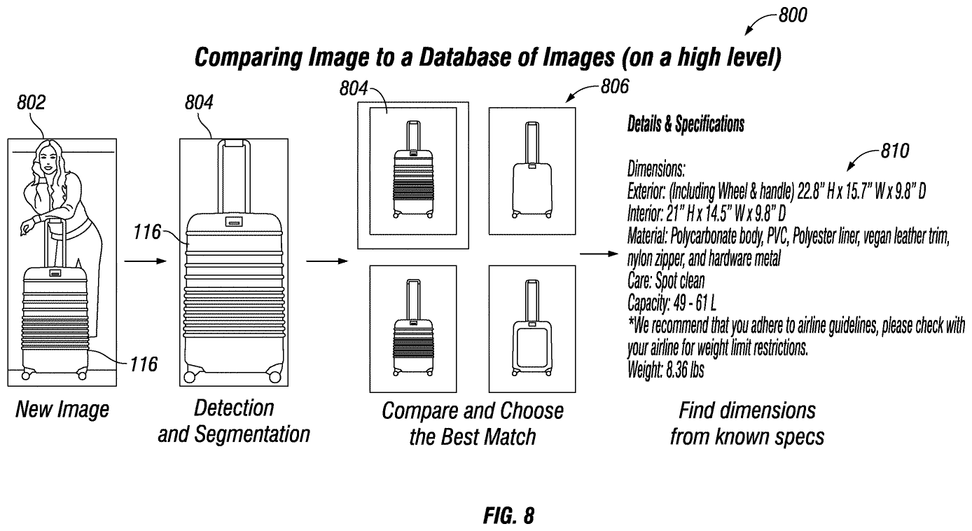

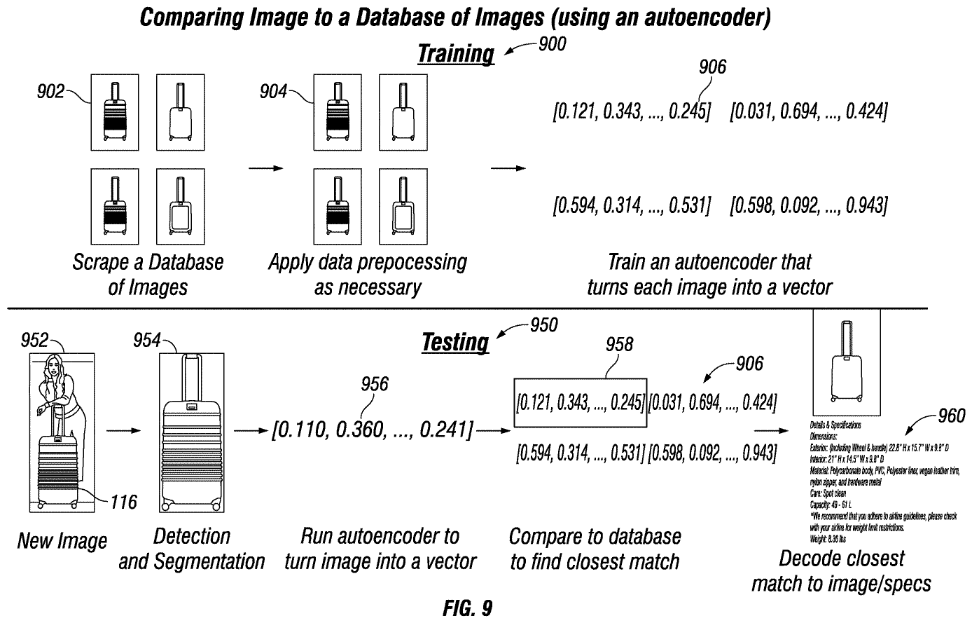

Database 122 may store captured luggage data for analysis. Database 122 may also store luggage images or 3D models with known dimensions to enable comparison to captured luggage data, precise sizing and/or measurement, and optimal bin assignments. Comparison of stored luggage images to captured luggage data for is discussed in more detail with reference to FIGS. 8-9. Captured luggage data may also be stored to improve comparisons and optimize bin assignments. Database 122 may also store passenger associations, luggage counts, luggage tracking information, airplane storage space information, and the like. In the non-limiting exemplary embodiment illustrated in FIG. 1, database 122 may be stored in the computer readable medium 120. In another embodiment, database 122 may be stored remotely from server 112 and may be accessed by server 112 via the network 114. For example, database 122 may be a network attached storage (NAS) system. Other exemplary databases include but are not limited to the Integrated Postsecondary Education Data System (IPEDS) for colleges and the Global Distribution Systems (GDS) for airline tickets.

The communications interface 124 may support communications with other systems or devices. For example, the communications interface 124 could include a network interface card or a wireless transceiver facilitating communications over the network 114. The communications interface 124 may support communications through any suitable physical or wireless communication link(s).

The I/O unit 126 may allow for input and output of data. For example, the I/O unit 126 may provide a connection for user input through a keyboard, mouse, keypad, touchscreen, or other suitable input device. The I/O unit 126 may also send output to a display, printer, or other suitable output device.

The processing unit 118 may execute instructions that may be loaded into the computer readable medium 120. The processing unit 118 may include any suitable number(s) and type(s) of processors or other devices in any suitable arrangement. Example types of processing unit 118 include microprocessors, microcontrollers, digital signal processors, field programmable gate arrays, application specific integrated circuits, and discreet circuitry.

Processing unit 118 may analyze luggage data captured via sensors 102. Processing unit 118 may include a combination of AI-based and computer vision algorithms to identify, measure, and classify luggage in real time. For example, processing unit 118 may analyze camera frames using a combination of AI-based and classical computer vision techniques to detect people and luggage, determine the size of the luggage, including but not limited to convolutional neural networks (CNNs), corner detection, segmentation, edge detection and morphological operations, stereo vision and environmental calibration, person and pose detection, size assumptions, and database comparisons. Using CNNs, various models and algorithms can be used to detect luggage and people in the frame. Additionally, techniques like Harris Corner Detection can be used to identify key points on luggage for shape analysis, and segmentation methods such as GrabCut or other real-time object detection algorithm-based segmentation can be used to isolate luggage from the background. Canny edge detection and morphological closing can refine luggage contours and shapes. Known camera and environmental parameters can enable calibration, 3D reconstruction, and size estimation. Additionally, real-time, object-based detection identifies people and their poses (e.g., approximate locations of body parts), allowing contextual analysis of luggage (e.g., a bag near a person's back is likely a backpack, with a height no greater than the person's torso-to-shoulder distance). The system may also assume most luggage complies with standard size limits (e.g., 22″×14″×9″) and validates these assumptions by comparing luggage dimensions to a person's height or other reference points. Measurements may be taken continuously and averaged over time to improve accuracy. Processing unit 118 can also compare captured luggage data to stored luggage data to determine dimensions of the luggage 116. Comparison of captured luggage data to stored luggage data is discussed in greater detail with reference to FIGS. 7-8 and 11. Processing unit 118 can also include comparing a determined size of the luggage against a size and other spatial parameters of a storage space.

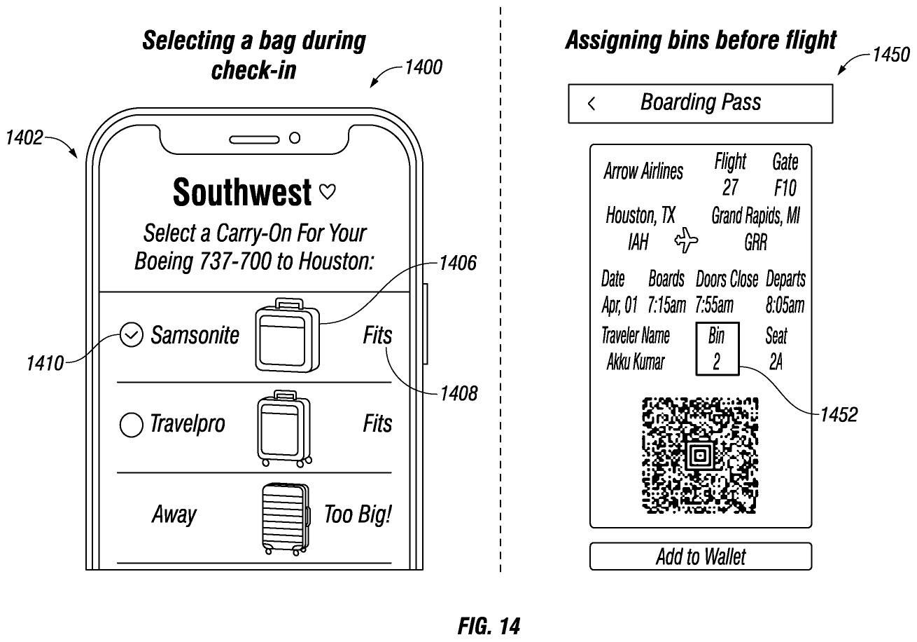

Based on luggage sizing determinations, the processing unit 118 may flag luggage that fails to comply with standard size limits (i.e., oversized bags). Processing unit 118 can also count each piece of luggage and persistently update the totals for different classes of items and/or associated with each flight. In an embodiment, system 100 may define one or more virtual boundaries within an observation zone. When a tracked object crosses a boundary, a counting event may be triggered such that each object is counted once. Based on luggage size determinations, baggage counts, and association between a piece of luggage 116 and a particular flight, processing unit 118 may also assign storage bins for each piece of luggage to optimize boarding and storage space. Processing unit 118 may also update boarding passes with storage bin assignments. Assignment of storage bins is discussed in more detail with reference to FIGS. 14 and 16-17.

Processing unit 118 may also track luggage 116 through the airport and during boarding. In an embodiment, processing unit 118 may assign each piece of luggage 116 a unique ID that can be tracked over time as the luggage 116 moves through the airport. For example, detected luggage 116 may be tracked over time using persistent identifiers such as characteristics of the luggage 116. This helps maintain continuity even when luggage 116 is temporarily occluded. Processing unit 118 can also associate bags with people based on spatial and temporal proximity and movement patterns, further improving tracking of luggage 116 through the airport.

Processing unit 118 may also keep track of bags already loaded onto the aircraft, and/or their bin assignment, thus eliminating the need for gate agents to manually or mentally keep track of the number and sizes of bags coming on board the aircraft. More particularly, by detecting and sizing of luggage of all passengers boarding an airplane, the processing unit 118 can calculate, in real time, an available storage space on the airplane (i.e., overhead storage, under seat storage, etc.) as passengers board the airplane. The real-time calculation of available space can be provided to a gate agent, thereby allowing the gate agent to make decisions as to whether or not to allow additional luggage to be carried onto the airplane. For example, processing unit 118 may generate output corresponding to the real-time calculation of available space. The output may be delivered to a gate agent user interface via the I/O unit 124.

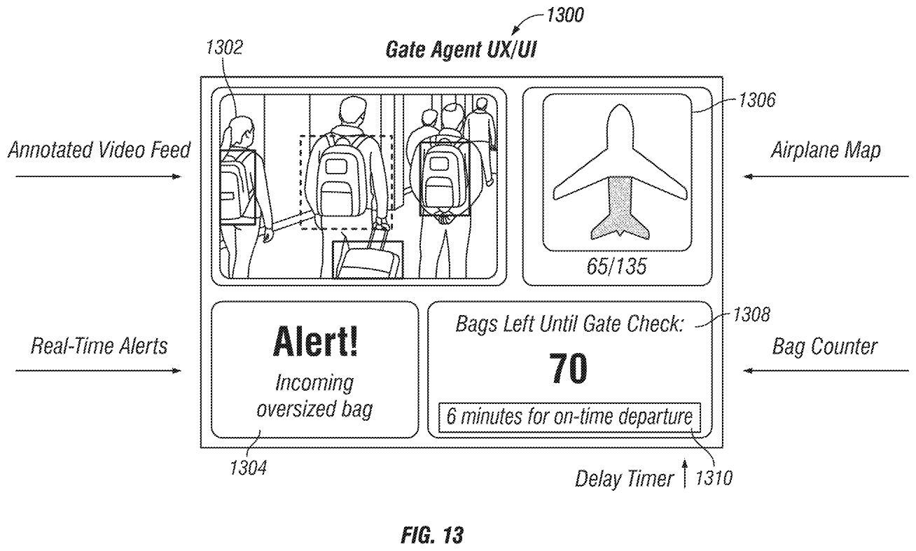

Processing unit 118 may also generate output for delivery to a user interface via I/O unit 124. User interfaces may include, for example, mobile devices 104 and gate agent user interface 110. For example, processing unit 118 may generate outputs corresponding to real-time bag counts, bag sizes, passenger associations, assigned storage bins, and baggage tracking, which can be displayed in a dashboard or sent to another system. Exemplary outputs are discussed in more detail with reference to FIGS. 13-14, 16, and 22. Processing unit 118 may also process stored luggage, storage, and tracking data for delay analysis.

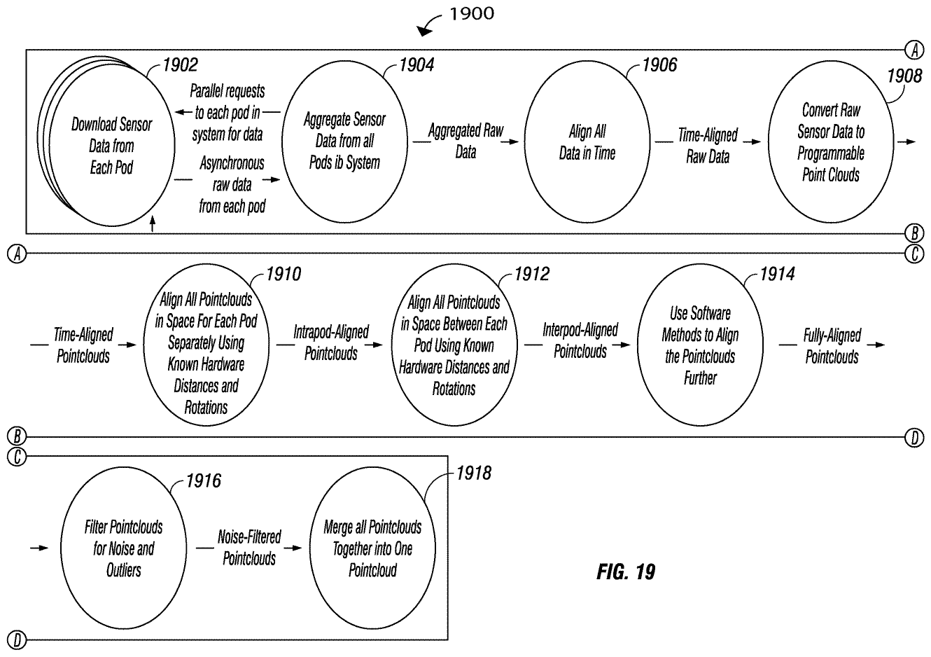

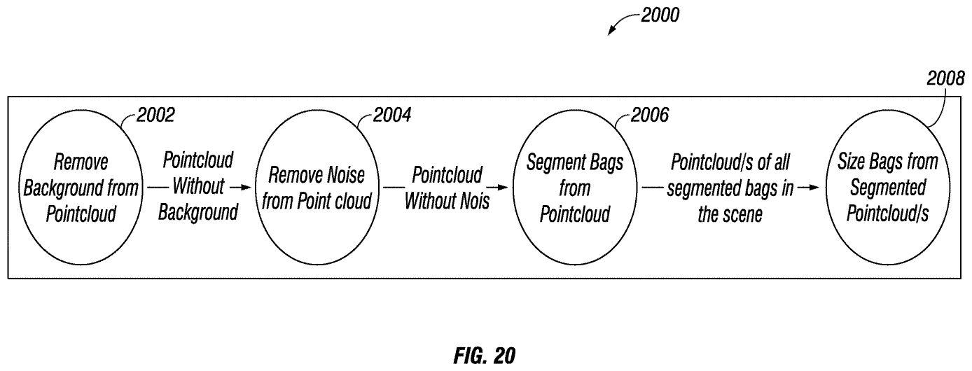

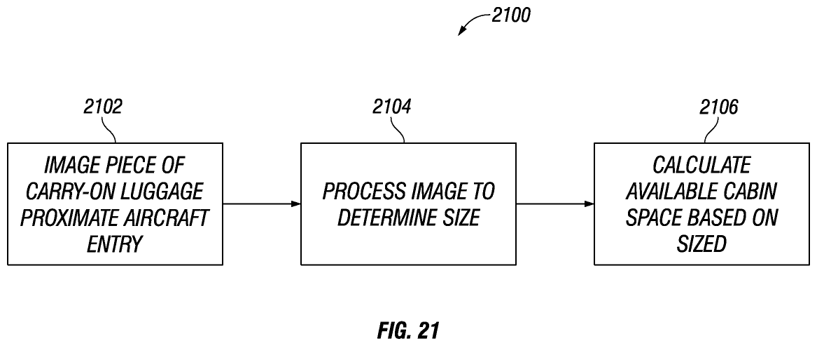

In an embodiment, processing unit 118 may include a data alignment and preprocessing layer to process raw sensor outputs to create a unified dataset suitable for downstream analysis, addressing challenges posed by distributed, asynchronous data sources, described in more detail with reference to FIG. 19. Processing unit 118 may also include a baggage detection and management layer to perform object segmentation and metrology, described in more detail with reference to FIG. 20. Processing unit 118 may also include an analytics layer to interpret baggage measurements within a carrier context to generate insights, discussed in greater detail with reference to FIG. 21.

System 100 may also include one or more applications 128. Application 128 may be stored in one or more of the mobile devices 104, the airline systems 108, and/or server 112.

In operation, the user approaches the boarding gate with carry-on luggage 116. The sensor 102 captures data associated with the luggage 116. Captured data is provided to the server 112 and analyzed by the processing unit 118 to detect the luggage 116, segment the luggage 116 from the background, and estimate the luggage 116′s dimensions. The processing unit 118 may also classify, count, associate, and track the luggage 116. The processing unit 118 may also flag non-compliant luggage 116. The processing unit 118 may also determine a storage bin assignment based on luggage and airplane storage space data. Storage bin assignments can be provided to passengers and/or gate agents to improve efficiency of boarding and luggage storage.

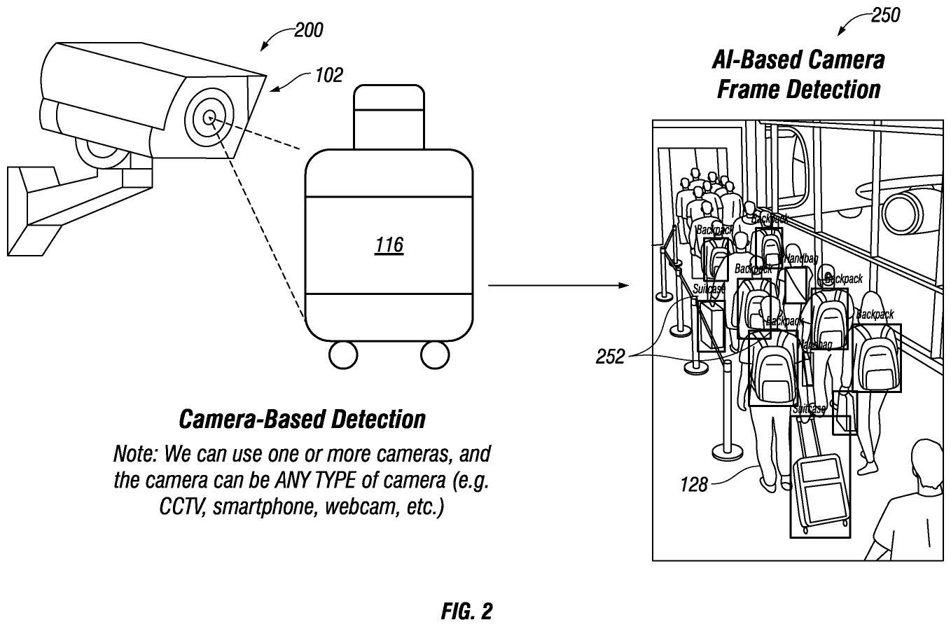

Referring to FIG. 2, illustrated is sensor and AI-based detection of a number of luggage units. As previously described, the luggage detection, sizing, and management system may employ camera-based detection 200, wherein sensors 102 comprise one or more visual capturing or recording devices such as a camera to capture data corresponding to the luggage 116 before it is loaded onto an aircraft for a flight. Sensor 102 may capture video or still images of passengers and their luggage in various locations of the airport. In an embodiment, sensors 102 may be employed proximate to a boarding gate. Sensors 102 may include a variety of camera types, including but not limited to CCTV cameras, smartphones, webcams, or other imaging devices. Camera types may also include, for example, depth cameras (e.g., RGB-D cameras capable of generating depth maps), LiDAR units (for high-precision 3D point clouds), or optical sensors (e.g., infrared cameras for low-light conditions). The system may use AI-based camera frame detection 250 to detect luggage 116 and determine luggage characteristics, such as luggage size and luggage type 252. For example, real-time, object-based detection can identify passengers 128 and their poses (e.g., approximate locations of body parts), allowing contextual analysis of luggage 116 and determination of luggage type 252 (e.g., a bag near a person's back is likely a backpack, with a height no greater than the person's torso-to-shoulder distance).

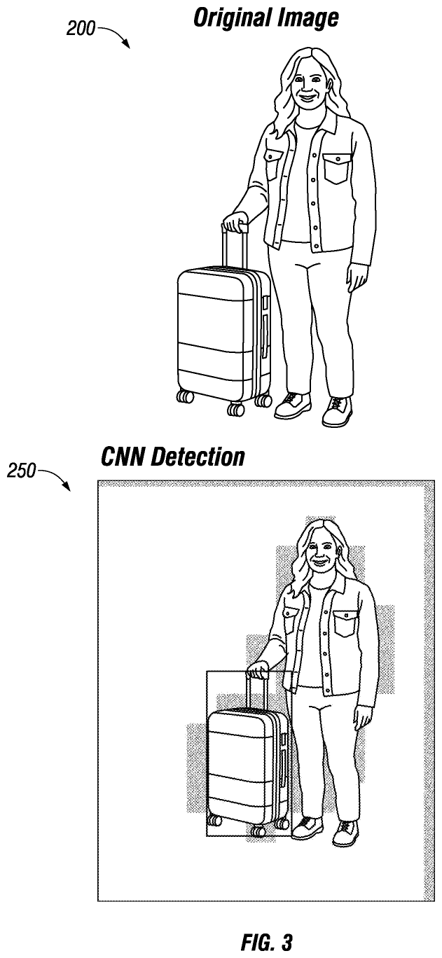

Referring to FIG. 3, illustrated is a comparison of a captured image 300 and an image processed by CNNs 350 for sizing detection. Using CNNs, various models and algorithms can be used to detect luggage and people in the frame. More particularly, CNNs may process visual inputs through multiple convolutional layers configured to extract hierarchical feature representations associated luggage characteristics. Based on the extracted features, the system may classify and localize objects within the visual data, such as by generating bounding boxes, segmentation masks, or object labels. The CNNs may be trained using annotated datasets and may continuously improve detection accuracy through additional training and/or feedback data.

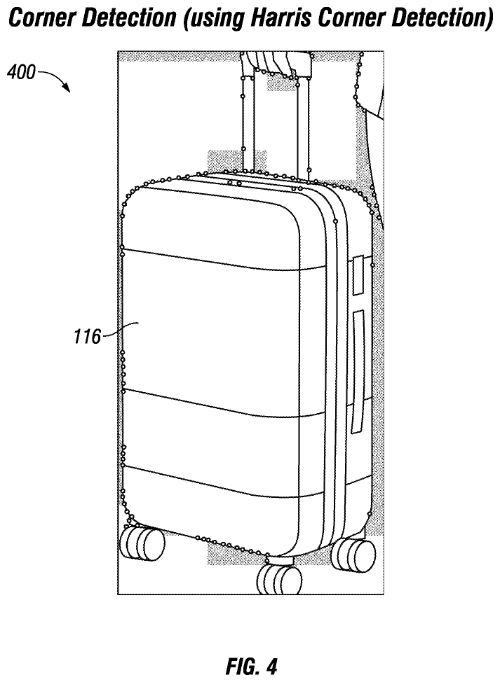

Referring to FIG. 4, illustrated is an exemplary corner detection 400 of a piece of luggage 116 using a Harris Corner Detection algorithm. Harris Corner Detection can be used to identify key points on luggage for shape analysis. More particularly, intensity gradients can be computed in orthogonal directions and a second-moment matrix over a local neighborhood of pixels can be formed. A corner response value can be derived to distinguish regions exhibiting significant variation in multiple directions from edges or uniform areas. Points exceeding a predefined threshold may be classified as corners, providing stable and repeatable features suitable for applications such as image registration, object recognition, and motion analysis.

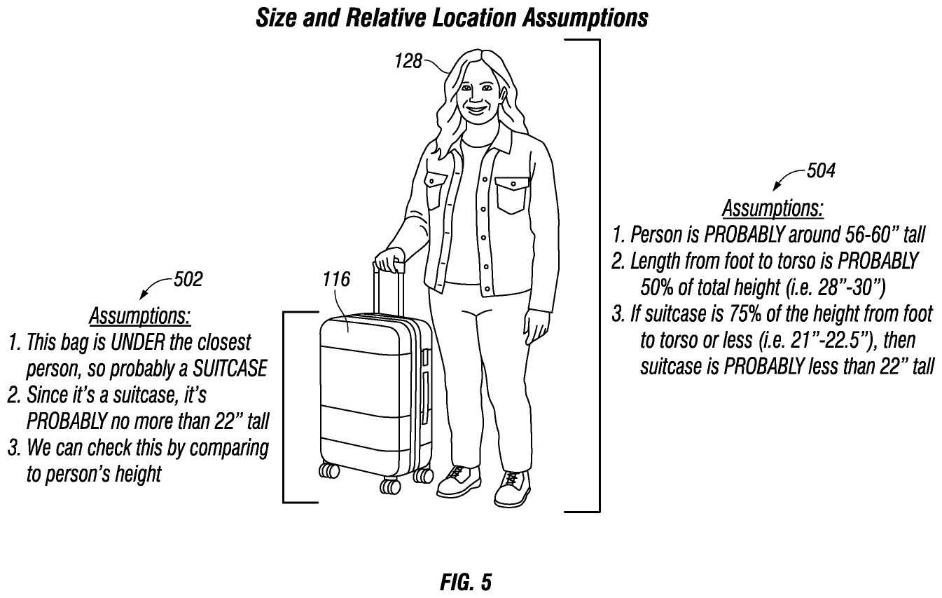

Referring to FIG. 5, illustrated are assumptions for a luggage size and location determination algorithm executed by the system described herein. The system incorporates person and pose detection to refine size estimates by analyzing the relative position and context of luggage (e.g., identifying a backpack near a person's shoulders). Assumptions for the luggage size and location determination algorithm may include luggage assumptions 502 and person assumptions 504. For example, luggage assumptions 502 may include relative locations of the luggage 116 and the person 128 as well as likely characteristics of the luggage 116. Person assumptions 504 may include likely characteristics of the person 128, including, for example, height and proportions. Using these assumptions 502, 504, the system may determine a likely size of the luggage 116.

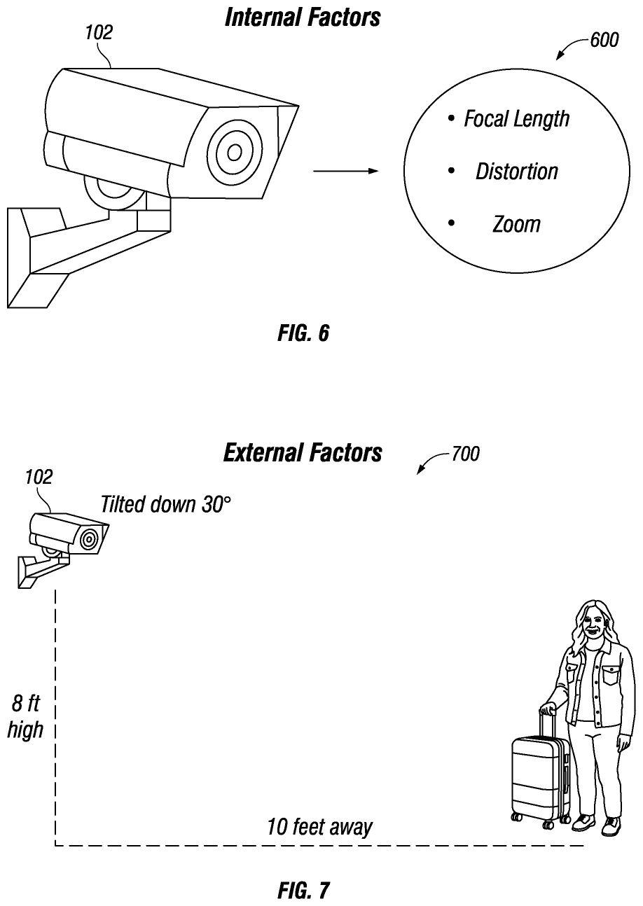

Referring to FIG. 6, illustrated are internal factors 600 of a camera platform that can be controlled in the system described herein. As previously described, the luggage detection, sizing, and management system may include sensors 102 comprising one or more visual capturing or recording devices such as a camera to capture data corresponding to the luggage. The system accounts for internal parameters 600 of the sensors 102 such as focal length, distortion, frame size, zoom, and focus. Internal parameters 600 of sensors 102 can be used to calibrate the system and ensure accurate measurements.

Referring to FIG. 7, illustrated is external factors 700 of a camera platform that can be controlled in a system described herein. The system also accounts for external environmental factors such as camera height, pan, and tilt, and distance to boarding gate. In the non-limiting exemplary embodiment illustrated in FIG. 7, a sensor 102 may be positioned 8 feet high, 10 feet from the gate, and tilted downward at 30 degrees. External camera parameters can be used to calibrate the system and ensure accurate measurements.

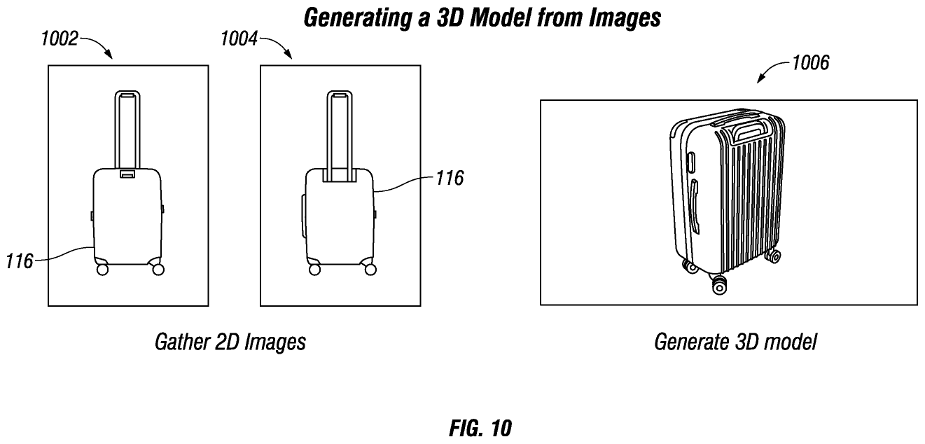

Referring to FIG. 8, illustrated is an exemplary real-time comparison of captured luggage data to images stored in the database for real-time determination of sizing. As previously discussed, the system may include a database storing luggage images or 3D models with known dimensions to enable comparison and precise sizing and/or measurement. For example, the database may include images of a particular luggage model in various orientations. In an embodiment, the images and/or 3D models may be augmented by generative methods (e.g., Generative Adversarial Networks (GANs), photogrammetry, or neural radiance fields (NeRFS)). As previously discussed, luggage data may be captured using sensors positioned in the airport. Captured images 802 of luggage 116 may be processed to generate a processed image 804. Processing may include, for example, detection and segmentation of luggage 116. Processed image 804 may be compared to a plurality of stored images 806 using a variety of methods, including but not limited to generative methods, autoencoders (discussed in more detail with reference to FIG. 9), and 3D model generation (discussed in greater detail with reference to FIG. 10). For example, generative methods such as GANS, photogrammetry, or NeRFs may be used to create synthetic images or 3D models. Additionally or alternatively, using 3D model generation, multiple 2D images may be processed to generate 3D models of luggage for precise sizing. The closest-matching stored image 808 may be identified and stored specifications 810 associated closest-matching stored image 808 may be used to estimate dimensions of the luggage 116.

Referring to FIG. 9, illustrated is an exemplary real-time comparison of a captured image to images stored in a database for real-time determination of sizing using an autoencoder. As previously mentioned, captured luggage images may be compared images stored in the database. Using an autoencoder, captured images 116 may be converted into vectors and compared to images stored in the database. The closest match in the database may be identified to estimate dimensions of the luggage 116. As illustrated in FIG. 9, using an autoencoder to compare captured images to stored images may include training 900 and testing 950. During training 900, stored images 902 may be scraped from the database. Stored images 902 may be processed as necessary to generate processed image 904. The autoencoder may then be trained to turn each stored image 902 and/or processed image 904 into a vector 906. During testing 950, captured images 952 of luggage 116 may be processed to generate a processed image 954. Processing may include, for example, detection and segmentation of luggage 116. The autoencoder may then be run to turn the processed image 954 into a vector 956. Vector 956 may be compared to stored vectors 906. The closest-matching stored vector 958 may be identified and decoded such that stored specifications 960 associated closest-matching stored vector 958 may be used to estimate dimensions of the luggage 116.

Referring to FIG. 10, illustrated is an exemplary three-dimensional model generated from one or more two-dimensional images. As previously discussed, captured luggage images may be compared to images stored in the database using 3D model generation. In an embodiment, multiple 2D images 1002, 1004 of luggage 116 may be processed to generate a 3D model 1006 of luggage 116 for precise sizing.

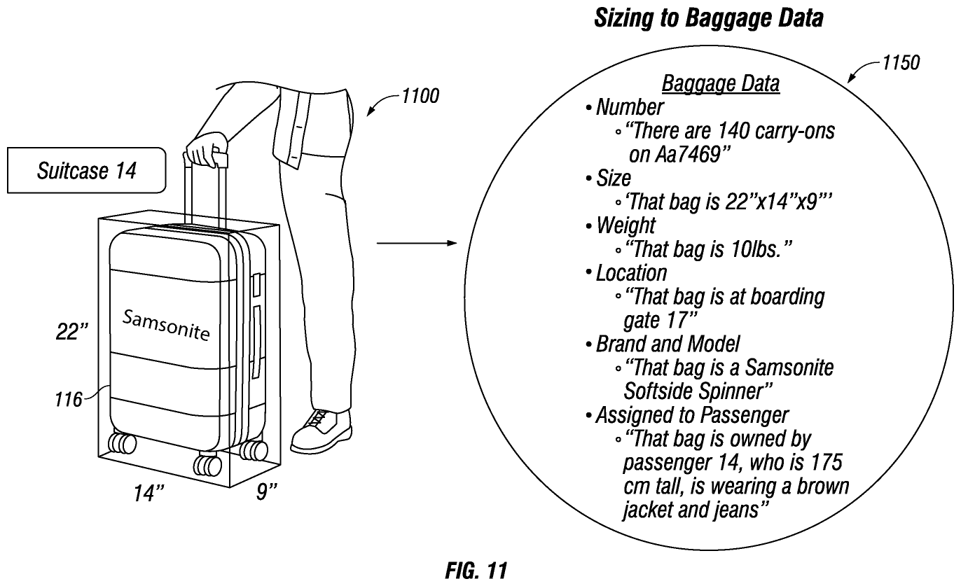

Referring to FIG. 11, illustrated is exemplary baggage data generated, stored, and output by the system. As previously mentioned, the system may process images of luggage 116 to detect luggage characteristics 1100, including but not limited to size, type (e.g., suitcase, backpack), model number, passenger associations, and compliance with size limits. During processing, luggage data 1150 associated with detected characteristics 1100 may be generated and stored in the database. Luggage data 1150 may include information about each piece of luggage 116 such as, for example, luggage size, weight, location, brand, model, and passenger association information. Passenger association may include passenger number as well as a passenger description. Luggage data 1150 may also include information about all the luggage on the flight such as, for example, a bag count, oversized bag count, and the like. The system may output real-time data to a frontend interface for gate agents (discussed in greater detail with reference to FIG. 13).

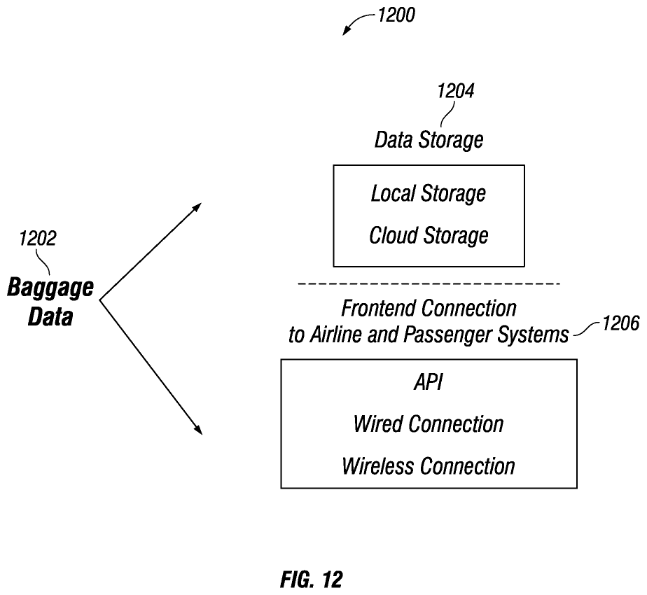

Referring to FIG. 12, illustrated are baggage data storage and user interface components of the system. As illustrated in FIG. 12, baggage data 1202 may be stored in data storage 1204. Data storage may include local storage and cloud storage. Data storge 1204 may be one or more of computer readable medium 120 and database 122 described with reference to FIG. 1. Baggage data 1202 may also be analyzed and provided to frontend connection to airline and passengers systems 1206 via one or more of an API, wired connection, wireless connection, and the like.

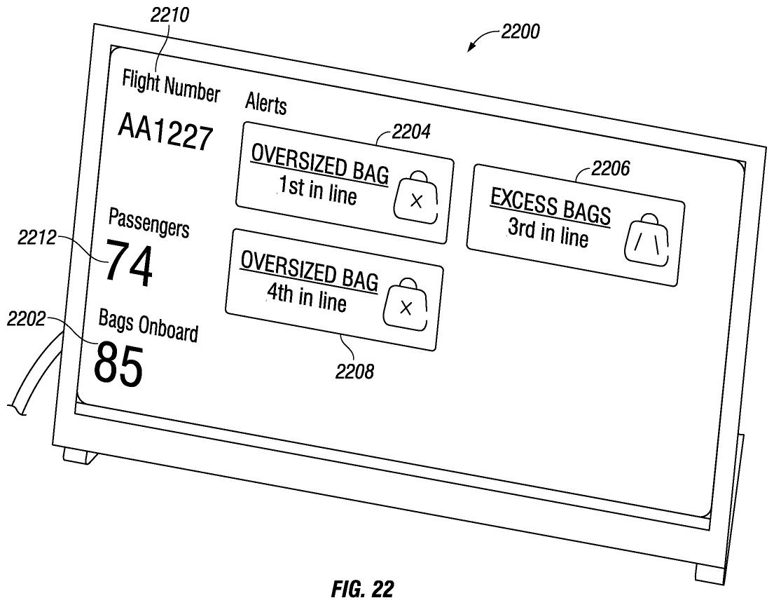

Referring to FIG. 13, illustrated is an exemplary output 1300 for delivery to a gate agent user interface generated by the system described herein. As previously discussed, the system may output real-time luggage data to gate agents via a graphic user interface on a computer screen and/or mobile device, for example. In an embodiment, data may be integrated with airline systems. The real-time data may include, for example, annotated video feeds 1302, alerts for oversized bags 1304, a boarded passenger count 1306, a bag count 1308, and a delay timer 1310. In an embodiment, data may also include storage bin assignment and boarding pass updates. By automating luggage inspection, the invention reduces boarding delays, enhances compliance with size restrictions, and improves passenger experience. An additional output for delivery via a gate agent user interface is discussed with reference to FIG. 22.

Referring to FIG. 14, illustrated are exemplary outputs for display on a passenger user interface generated by a system described herein. In an embodiment, the system can include integration with one or more object conveyance enterprises, such as airline systems. In an airline context, the system can allow passengers to select bags during check-in. Using this information, the system can determine bag size, assign overhead space, and provide luggage information to gate agents. In the non-limiting exemplary embodiment illustrated in FIG. 14, output 1400 may include a plurality of carry-on luggage options 1402. Output 1400 can include luggage brand and/or model names 1404 and an image 1406 associated with each carry-on luggage option 1402. Output 1400 may also include a classification 1408 of each luggage option 1402 corresponding to the size of the luggage option 1402 relative to standard or airline-specific size restrictions. For example, classifications 1408 may include “Fits” or “Too Big.” The user may select one of the plurality of carry-on luggage options 1402 via the user interface. In the non-limiting exemplary embodiment illustrated in FIG. 14, each carry-on luggage option may be associated with a selectable checkbox 1410 by which the user may select one of the plurality of carry-on luggage options 1402. Based on this information, the system can assign overhead storage bins for each passenger's luggage before boarding, update boarding passes with assigned bins, and analyze delays caused by luggage issues. In the non-limiting exemplary embodiment illustrated in FIG. 14, boarding pass 1450 may include a storage bin assignment 1452 corresponding to the passenger. Boarding pass 1450 may also include conventional information, such as airline name, flight number, gate number, departure and destination location, date, boarding time, traveler name, seat assignment, departure time, and scannable code such as a QR code.

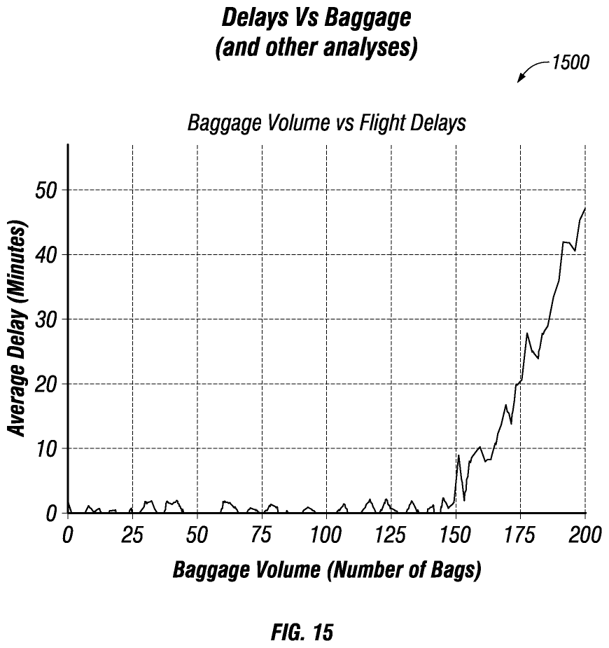

Referring to FIG. 15, illustrated is a graph depicting the relationship between delays and the number of bags to be carried on an airplane using conventional baggage management systems. As illustrated in FIG. 15, baggage volume exceeding 150 bags is associated with significant delays using conventional baggage management systems. Common, narrow-body, short-haul jets (e.g., Boeing 737 or Airbus A320) generally hold 150-200 passengers, while large, long-haul wide-body planes (e.g., Airbus A380) can carry over 500 passengers. With most airlines allowing one carry-on bag per passenger, baggage volume frequently exceeds 150 bags, making associated delays common using conventional baggage management. The system and method described herein provides an automated, accurate, and scalable system that leverages advanced AI and computer vision to detect and size carry-on luggage in real time and provide actionable data to carriers or conveyers of the objects such as gate agents and passengers, thereby improving luggage management and preventing significant delays associated with large luggage volumes.

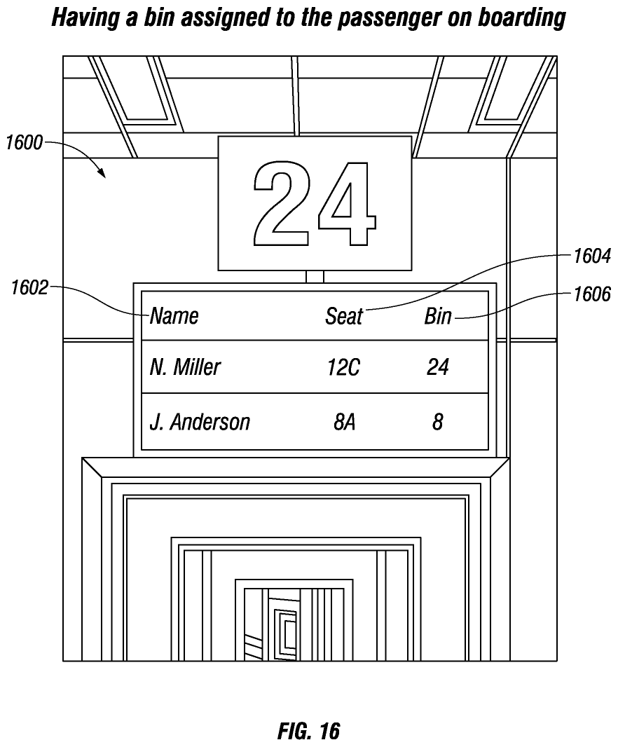

Referring to FIG. 16, illustrated is an additional output 1600 for display via a boarding gate user interface generated by the system described herein. As previously described, the system may assign storage bins for each piece of luggage to optimize boarding and storage space based on luggage size determinations, baggage counts, and/or storage space information. Storage bin assignments can be displayed to gate agents and passengers. In an embodiment, storage bin assignments can be displayed via a boarding gate user interface, thereby enabling gate agents and passengers to review storage bin assignments before and during boarding. In the non-limiting exemplary embodiment illustrated in FIG. 16, output 1600 may include passenger name 1602, assigned seat number 1604, and assigned storage bin 1604 for the passenger's luggage displayed via a boarding gate user interface mounted proximate to the boarding gate.

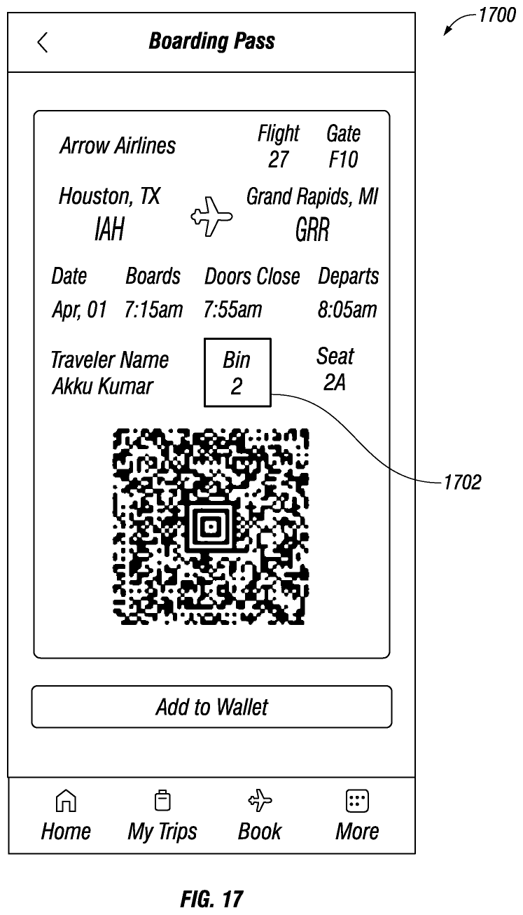

Referring to FIG. 17, illustrated is an exemplary boarding pass 1700 providing information generated by the system described herein. Boarding pass 1700 may include conventional information, such as airline name, flight number, gate number, departure and destination location, date, boarding time, traveler name, seat assignment, departure time, and scannable code such as a QR code. Boarding pass 1700 may also include a storage bin assignment 1702 corresponding to the passenger. As previously discussed, using luggage sizing information, the system can assign overhead storage bins for each passenger's luggage before boarding and update boarding passes with assigned storage bins.

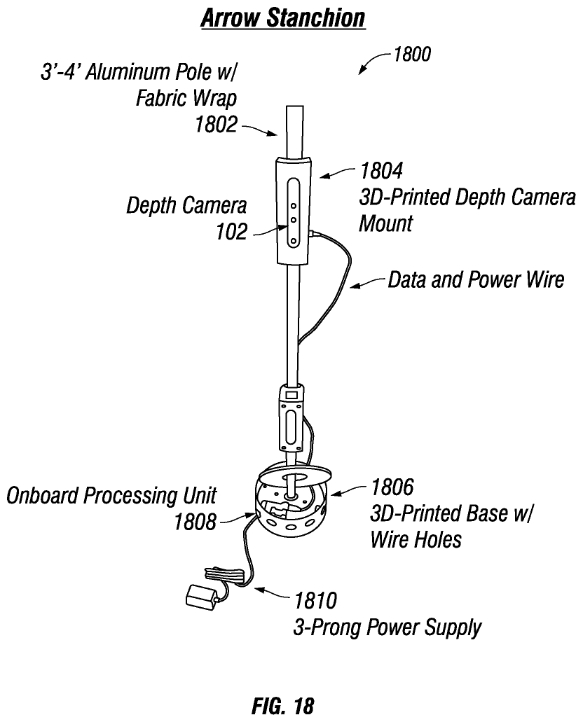

Referring to FIG. 18, illustrated is a sensor pod 1800 for capturing luggage data. In an embodiment, each sensor pod 1800 may serve as a self-contained, modular sensing unit optimized for deployment in airport environments, such as boarding gates, queues, or security areas. The design prioritizes portability, durability, and precise sensor alignment to ensure reliable data capture in dynamic settings. Sensor pods 1800 may include an adjustable frame 1802. Frame 1802 can be adjusted to accommodate various heights and angles in accordance with installation needs. In an embodiment, frame 1802 may be constructed from off-the-shelf aluminum plates and poles, providing a lightweight yet sturdy structure resistant to daily wear. In the non-limiting exemplary embodiment illustrated in FIG. 18, frame 1802 may be a ¾-inch diameter vertical pole wrapped in fabric for aesthetics and protection.

Sensor pods 1800 may also include sensor mounts 1804 to hold sensors 102 at predetermined orientations for capturing spatial data. As previously discussed, sensors 102 may include, for example, depth cameras (e.g., RGB-D cameras capable of generating depth maps), LiDAR units (for high-precision 3D point clouds), or optical sensors (e.g., infrared cameras for low-light conditions). In an embodiment, sensor mounts 1804 may be custom-designed 3D-printed or machined mounts. Sensor mounts 1804 may ensure fixed extrinsics (i.e., relative positions and rotations) between sensors 102 and may be calibrated during assembly to minimize alignment errors.

Sensors pods 1800 may also include a housing 1806 enclosing various electronic components, including, for example, an embedded computing module 1808, networking components (not shown), and a power supply 1810. In an embodiment, the embedded computing module 1808 may include, for example, a single-board computer like Raspberry Pi or NVIDIA Jetson for real-time processing. Networking components may include, for example, Ethernet ports, Wi-Fi modules, and/or cellular modems. Power supply 1810 may include, for example, a 3-prong AC adapter or battery for mobile use. In an embodiment, networking components and power supply 1810 may be provided by a Power-over-Ethernet (POE) to simplify cabling by combining power and data. In an embodiment, housing 1806 may also include cooling mechanisms to handle continuous operation. In the non-limiting exemplary embodiment illustrated in FIG. 18, housing 1806 may also function as a base providing stability for the sensor pod 1800.

In the non-limiting exemplary embodiment illustrated in FIG. 18, sensor pods 1800 may be a stanchion-integrated pod such that sensor pod 1800 may be embedded into gate dividers or boarding lane barriers, blending seamlessly with airport aesthetics while providing close-range sensing. In other embodiments, sensor pods 1800 may be differently shaped. For example, in an embodiment, sensor pods 1800 may be tripod-mounted pods for temporary or trial deployments, allowing quick setup and repositioning without permanent fixtures. As another non-limiting example, sensor pods 1800 may be wall-or ceiling-mounted pods for fixed installations in high-traffic areas, integrated into existing infrastructure for unobtrusive monitoring.

Referring to FIG. 19, illustrated is a flowchart 1900 depicting a data alignment and preprocessing layer of system 100. The data alignment and preprocessing layer may process raw sensor outputs to create a unified dataset suitable for downstream analysis, addressing challenges posed by distributed, asynchronous data sources. The data alignment and preprocessing layer may also allow sensor pods to be positioned arbitrarily and enable coverage of extended areas. Alternatively, the sensor pods can be positioned specifically at or proximate to a carrier's entrance. The data alignment and processing layer may include fully local (edge-only for low-latency), fully remote (for resource-intensive computations), or hybrid (e.g., edge preprocessing with remote analytics) processing. Unlike fixed scanners, this location-agnostic approach allows dynamic reconfiguration without hardware relocation. The process illustrated in flowchart 1900 may be implemented in whole or in part in one or more of the system 100 disclosed herein. It shall be appreciated that a number of variations and modifications to the process illustrated in flowchart 1900 are contemplated including, for example, the omission of one or more aspects of the process, the addition of further conditionals and operations, or the reorganization or separation of operations and conditionals into separate processes.

Flowchart 1900 begins with Step 1902, wherein sensor data is downloaded from each sensor pod. As previously discussed, sensors capture spatial information, such as depth maps (i.e., pixel-wise distance arrays), 3D point clouds (i.e., collections of XYZ coordinates), or volumetric grids (i.e., 3D occupancy representations). Onboard processes timestamp each data frame using synchronized clocks and package it into compact, serialized packets (e.g., using protocols like JSON or Protocol Buffers). Optional edge preprocessing steps include spatial cropping to focus on regions of interest (e.g., excluding background walls), noise reduction via filtering algorithms (e.g., Gaussian blur on depth data), or downsampling to reduce data volume for transmission.

In Step 1904, sensor data from all sensor pods in the system is aggregated. In an embodiment, packaged data is streamed to a central server or cloud instance via secure channels (e.g., HTTPS or MQTT). The server aggregates incoming streams from multiple sensor pods, buffering them to handle network latencies.

In Step 1906, all data is aligned in time. Data synchronization may be achieved using Network Time Protocol (NTP) for sub-second accuracy, GPS timestamps in outdoor setups, or peer-to-peer clock offsetting. Alternatively, tolerance-based grouping may cluster data within a configurable window (e.g., ±50 ms) to form multi-sensor pod “snapshots.”

In Step 1908, raw sensor data may be converted to programmable point clouds. For example, raw sensor data may be converted into a point cloud by estimating depth information for the captured image, using either multiple viewpoints (e.g., stereo cameras) or depth estimation techniques. Each pixel in the image may then be then mapped into 3D space using the sensor's intrinsic parameters. By combining each pixel's position with its corresponding depth value, the system may compute 3D coordinates for visible points in the scene, resulting in a point cloud representation of the captured object or environment.

In Step 1910, point clouds for each sensor pod may be spatially aligned using known hardware distances and rotations. In an embodiment, local sensor pod data may be transformed into a global reference frame using pre-measured extrinsic parameters (e.g., via calibration with checkerboard patterns), fiducial markers (e.g., AR tags placed in the environment), or adaptive software methods (e.g., iterative closest point (ICP) algorithm for automatic correction).

In Step 1912, point clouds for all sensor pods may be spatially aligned using known hardware distances and rotations. More particularly, sensor pods may be positioned at a known fixed distance from one another, and capture images of a same object from different viewpoints. The known sensor pod separation may be used as a baseline to assist in aligning corresponding point clouds from each sensor pods. Using the fixed distance and sensor calibration information, a relative spatial transformation between the views may be determined and applied so that the resulting data is represented in a common coordinate system for further processing.

In Step 1914, software methods may be used to align point clouds further. Alignment may include, for example, determining one or more spatial transformations, such as translational, rotational, and/or scaling transformations, that reduce differences between corresponding portions of the point clouds. The alignment process may be based on identified feature points, geometric descriptors, surface normals, intensity values, machine learning models, iterative optimization techniques, and/or correspondence matching between points or regions of the respective point clouds.

In Step 1916, point clouds may be filtered for noise and outliers. More particularly, filters may be applied to identify and remove artifacts and resolve occlusions from multiple viewpoints. For example, one or more filtering techniques may be applied to identify and remove outlier points, spurious measurements, and other artifacts generated by sensor error, environmental interference, or motion-related distortion. For example, the system may utilize statistical methods like RANSAC, radius-based filtering, voxel grid filtering, clustering operations, and/or machine learning models configured to distinguish valid spatial data from noise. The resulting filtered point cloud may exhibit improved spatial consistency and reduced data irregularities, thereby increasing the accuracy and efficiency of downstream processing operations.

In Step 1918, all point clouds may be merged together into one point cloud. More particularly, aligned data from each sensor pod may be combined into a cohesive representation of data from all sensor pods. Unified data may be used to detect and measure luggage, described in more detail with reference to FIG. 20.

Referring to FIG. 20, illustrated is a flowchart 2000 depicting a baggage detection and measurement layer of the system 100. Utilizing the preprocessed unified data generated by the data alignment and preprocessing layer described in FIG. 19, the baggage detection and measurement layer performs object segmentation and metrology. The process illustrated in flowchart 2000 may be implemented in whole or in part in one or more of the system 100 disclosed herein. It shall be appreciated that a number of variations and modifications to the process illustrated in flowchart 2000 are contemplated including, for example, the omission of one or more aspects of the process, the addition of further conditionals and operations, or the reorganization or separation of operations and conditionals into separate processes.

Flowchart 2000 may begin with Step 2002, wherein the background is removed from the point cloud to isolate luggage. The system may utilize segmentation techniques, depth analysis, thresholding operations, background subtraction algorithms, and/or machine learning models configured to distinguish luggage from surrounding environmental features. Background data determined to be unrelated to luggage detection or analysis may be suppressed, filtered, masked, or removed from further processing. Removing background information may reduce computational overhead and improve the accuracy of object detection, classification, tracking, and/or scene analysis operations.

In Step 2004, noise may be removed from the point cloud. For example, one or more filtering techniques may be applied to identify and remove outlier points, spurious measurements, and other artifacts generated by sensor error, environmental interference, or motion-related distortion. For example, the system may utilize statistical outlier removal, radius-based filtering, voxel grid filtering, clustering operations, and/or machine learning models configured to distinguish valid spatial data from noise. The resulting filtered point cloud may exhibit improved spatial consistency and reduced data irregularities, thereby increasing the accuracy and efficiency of downstream processing operations.

In Step 2006, bags may be segmented from the point cloud. More particularly, baggage may be segmented as distinct entities from passengers using machine learning models (e.g., semantic segmentation with U-Net architectures trained on labeled datasets), distinguishing items like suitcases from clothing or accessories. In an embodiment, computer vision techniques (e.g., pose estimation models like OpenPose) may be employed to detect human figures within the sensing zone, tracking their movement over time.

In Step 2008, bags may be sized from segmented point clouds. More particularly, real-world dimensions (length, width, height) of luggage may be computed by fitting bounding boxes or oriented bounding volumes to segmented point clouds, converting sensor units (e.g., pixels or voxels) to physical units via calibrated intrinsics. In an embodiment, measurements may be stabilized and finalized as the passenger exits a zone, ensuring accuracy despite motion. Baggage size information may be used to generate baggage, storage, and delay insights, discussed in greater detail with reference to FIG. 21.

Referring to FIG. 21, illustrated is a flowchart 2100 depicting an analytics layer of system 100. The analytics layer interprets baggage measurements within a carrier context to generate insights. By contextualizing data, the analytics layer enables delay reductions and operational optimizations. The process illustrated in flowchart 2100 may be implemented in whole or in part in one or more of the system 100 disclosed herein. It shall be appreciated that a number of variations and modifications to the process illustrated in flowchart 2100 are contemplated including, for example, the omission of one or more aspects of the process, the addition of further conditionals and operations, or the reorganization or separation of operations and conditionals into separate processes.

Flowchart 2100 begins with Step 2102, wherein pieces of luggage proximate to carrier entry are imaged. As previously described, the system may include one or more cameras to collect luggage images.

In Step 2104, the image is processed to determine luggage size. Image processing for sizing is discussed in more detail above. Using size information, the system may flag violations against carrier thresholds (e.g., >22×14×9 inches) with confidence scores.

In Step 2106, available storage space is calculated based on luggage size. Based on calculated available storage space, the analytics layer can predict storage bin fullness using cumulative volume estimates and historical data models (e.g., regression algorithms). The analytics layer can also provide storage allocation recommendations. For example, the analytics layer can suggest storage of a given piece of luggage in an overhead bin as opposed to under-seat placement based on bag dimensions and airline policies.

Analytics layer can also classify luggage into categories (e.g., suitcase, backpack, handbag) using feature extraction (shape, size histograms), thereby allowing the system to provide bag counts associated with each category. Analytics layer can also link bags to passengers via proximity tracking and/or trajectory analysis. Analytics layer can also calculate boarding flow rates, detect congestion via density maps, identify bottlenecks. Analytics layer may also track excess baggage frequency for reporting. Using this information, the system may generate historical and real-time dashboards illustrating trends for staff review.

Referring to FIG. 22, illustrated is an exemplary output 2200 for display via a gate agent user interface. Output 2200 may also be referred to herein as gate agent dashboard 2200. In an embodiment, the gate agent dashboard 2200 may be an intuitive web or app-based interface showing live bag counts 2202. Gate agent dashboard may also include oversize bag alerts 2204 flagging oversize bag detection and allocation alerts 2206 flagging bags exceeding the per-passenger bag allocation. In an embodiment, oversize bag alerts 2204 and allocation alerts 2206 may include the positions 2208 of the offending bags (e.g., “POS: 1st in line”). In an embodiment, the gate agent dashboard 2200 may provide simple visuals and alerts, thereby requiring minimal training. Gate agent dashboard 2200 may also include a flight number 2210 corresponding to the currently boarding flight and a passenger count 2212 corresponding to the number of passengers on the plane. Gate agent dashboard 2200 may also include APIs for airline system integration (e.g., RESTful endpoints for real-time data), logs/reports for audits, and optional exports (CSV, video) for compliance.

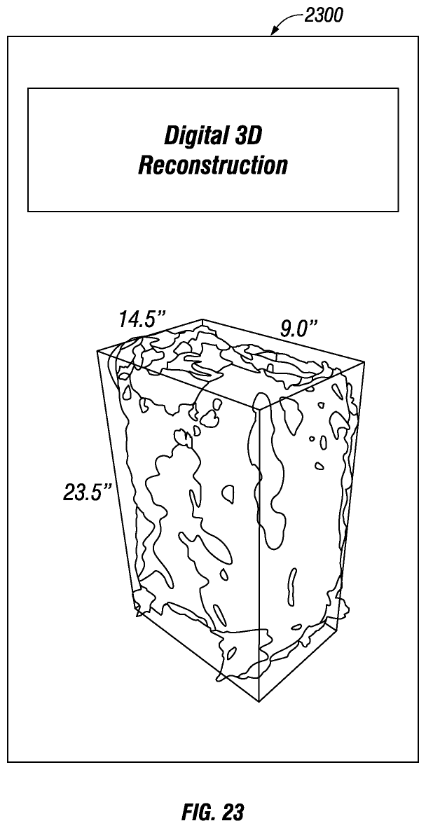

Referring to FIG. 23, illustrated is an exemplary 3D reconstruction 2300 of a piece of luggage. As previously discussed, captured luggage images may be compared to images stored in the database using 3D model generation. In an embodiment, multiple 2D images of luggage 116 may be processed to generate a 3D model 2300 of luggage for precise sizing.

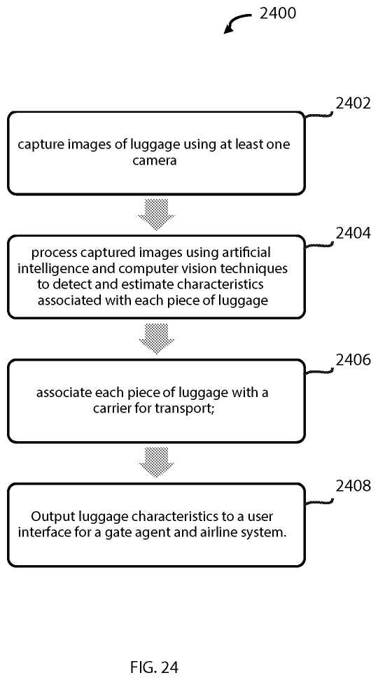

Referring to FIG. 24, illustrated is a flowchart 2400 of a process for detecting, sizing, and managing luggage. The process illustrated in flowchart 2400 may be implemented in whole or in part in one or more of the system 100 disclosed herein. It shall be appreciated that a number of variations and modifications to the process illustrated in flowchart 2400 are contemplated including, for example, the omission of one or more aspects of the process, the addition of further conditionals and operations, or the reorganization or separation of operations and conditionals into separate processes.

Flowchart begins with Step 2402, wherein images of luggage are captured using at least one camera. In Step 2402, images are processed using artificial intelligence and computer vision techniques to detect and estimate characteristics associated with each piece of luggage. In Step 2406, each piece of luggage is associated with a carrier for transport. In Step 2408, luggage characteristics are output to a user interface for a gate agent and airline system.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

While this disclosure has been particularly shown and described with reference to preferred embodiments, it will be understood by those skilled in the pertinent field of art that various changes in form and detail may be made therein without departing from the spirit and scope of the disclosed principles. The inventors expect skilled artisans to employ such variations as appropriate, and the inventors intend the disclosed principles to be practiced otherwise than as specifically described herein. Accordingly, this disclosure includes all modifications and equivalents of the subject matter recited in the claims appended hereto, as permitted by applicable law. Moreover, any combination of the above-described elements in all possible variations thereof is encompassed by the disclosure unless otherwise indicated herein or otherwise clearly contradicted by context.

Also, while various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the disclosed principles set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” or disclosed principles in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

Any and all publications, patents, and patent applications cited in this disclosure are herein incorporated by reference as if each were specifically and individually indicated to be incorporated by reference and set forth in its entirety herein.

We claim:

1. A system for detecting, sizing, and managing luggage, comprising:
at least one camera configured to capture images of luggage;
a memory storing captured images, reference images and dimensions, generated output, and instructions;
a processor communicatively coupled to the at least one camera, and the memory, wherein the processor is configured to execute the instructions to:
analyze the captured images in real time using artificial intelligence and computer vision techniques to determine characteristics associated with each piece of luggage;
associate each piece of luggage with a carrier for transport;
generate output corresponding to luggage characteristics; and
a user interface communicatively coupled to the processor and configured to display generated output to a gate agent and integrate with airline systems.

2. The system of claim 1, wherein artificial intelligence and computer vision techniques include one or more of convolutional neural networks, corner detection, segmentation, and edge detection.

3. The system of claim 1, wherein the processing unit is further configured to detect people and their poses in the images to refine luggage characteristics based on contextual relationships between the luggage and people.

4. The system of claim 1, wherein the processing unit compares a captured image to reference images using an autoencoder to identify a closest match and estimate dimensions.

5. The system of claim 1, wherein the processing unit generates a 3D model of the luggage using photogrammetry or neural radiance fields based on multiple 2D images.

6. The system of claim 1, wherein the processing unit maintains a real-time count of luggage associated with a carrier.

7. The system of claim 1, wherein the processing unit assigns a unique identification number to each piece of luggage and tracks luggage throughout a space.

8. The system of claim 1, wherein the processing unit is further configured to calculate available storage space on a carrier in real time.

9. The system of claim 1, wherein the processing unit generates storage bin assignments for each piece of luggage based on luggage characteristics and available store space.

10. The system of claim 1, wherein the camera is calibrated using internal parameters, including one or more of focal length, distortion, and frame size, zoom, and focus, and external parameters, including one or more of height, distance, tilt, and pan.

11. The system of claim 1, wherein the user interface provides real-time alerts for oversized luggage and storage bin assignments.

12. The system of claim 1, wherein the processing unit comprises:
a data alignment and preprocessing layer to process raw camera outputs to create a unified dataset suitable for downstream analysis;
a baggage detection and management layer to perform luggage segmentation and metrology; and
an analytics layer to interpret luggage measurements within a carrier context to generate insights.

13. A method for detecting, sizing, and managing luggage, comprising:
capturing images of luggage using at least one camera;
processing the images using artificial intelligence and computer vision techniques to detect and estimate characteristics associated with each piece of luggage;
associating each piece of luggage with a carrier for transport;
outputting luggage characteristics to a user interface for a gate agent and airline system.

14. The method of claim 13, wherein processing images comprises comparing the processed images to a database of luggage images or models with known dimensions.

15. The method of claim 13, further comprising detecting people and their poses in the images to refine luggage characteristics.

16. The method of claim 13, wherein processing the images includes using one or more of convolutional neural networks, segmentation, and edge detection.

17. The method of claim 13, further comprising generating synthetic luggage images or 3D models using generative adversarial networks or photogrammetry to augment the database.

18. The method of claim 13, further comprising calculating available storage space on a carrier in real time.

19. The method of claim 13, further comprising generating storage bin assignments for each piece of luggage based on luggage characteristics and available store space.

20. The method of claim 13, further comprising tracking and counting luggage associated with a carrier.
